(19) United States
(12) Patent Application Publication
(10) Pub. No.: US 2008/0128260 A1
(43) Pub. Date: Jun. 5, 2008

(54) Small and efficient distillation apparatus for extraction of essential oils from plant matter

(76) Inventor: Moshe Balass, OR YEHUDA (IL)

Correspondence Address: MOSHE BALASS, 59 HERZEL St., OR YEHUDA, 60211, omitted

(21) Appl. No.: 11/987,602

(22) Filed: Dec. 3, 2007

(30) Foreign Application Priority Data
Dec. 5, 2006 (IL) 179842

(51) Int. Cl. B01D 3/00

(52) U.S. Cl. 202/176

(57) ABSTRACT

The present invention relates to a distillation apparatus and method for extracting high quality volatile oils, such as essential oils, from organic matter, particularly from plants.

### BACKGROUND OF THE INVENTION

Extraction of volatile oils from plant matter is not new. One well established apparatus is the so called Clevenger type apparatus described in Clevenger J. F., “Apparatus for the determination of volatile oil”. J. Amer. Pharm. Assoc., 17, p. 346 (1928). This apparatus consists of a spherical glass vessel charged with the plant material containing the oil to be extracted together with water in the ratio of one part plant matter to two parts water. The device has a narrow opening and the vessel is put onto a heating mantle, with an energy regulator for controlling the temperature. The vapors produced from the mixture are passed through a long vertical glass tube (delivery tube) to a vertical condenser having a long vertical glass tube. Cooling water enters the jacket of the condenser tube by an inlet and is circulated therearound prior to being discharged through an outlet to a graduated collection vessel, typically a measuring tube, which is open to the atmosphere. The volatile oil is immiscible in water and, being less dense, separates out as an upper layer. A return conduit connects the base of the measuring tube to the vertical tube and allows recycling of the aqueous part of the vapors. The oil is collected at the outlet by opening a valve provided for that purpose.

A first major drawback of the Clevenger type apparatus is that it was designed to distil plant material by hydro distillation only. There are some aromatic plant materials however, that cannot be extracted by hydro distillation, and are only distillable by a steam distillation method. One reason for their unsuitability for regular hydro distillation is that some of the volatile constituents get hydrolyzed due to the presence of excess water in the vessel. Additionally, there are many dried plant materials, such as dry cardamom fruits, for example, whose volatile oils though easily extracted by steams are almost not extractable by boiling water.

A second limitation of the Clevenger apparatus is that it includes a vessel, a long vertical delivery tube and a condenser having a long vertical glass tube; all of which are made of glass, and therefore require careful handling to avoid breakages. It is inappropriate for use by unskilled people, such as under domestic conditions, for example.

A third limitation of the Clevenger is the narrow diameter of the mouth of the glass vessel through which plant material is loaded and removed.

In summary, the drawbacks of the Clevenger are:
1. It can not distill the plant material by steam distillation method;
2. Its parts are made of glass, which is non durable;
3. It is difficult to load and remove plant material from its vessel; and

These drawbacks are addressed by U.S. Pat. No. 6,911,119 to Babu et al. entitled “Simple portable mini distillation apparatus for the production of essential oils and hydrosols”, incorporated herein by reference. U.S. Pat. No. 6,911,119 relates to a simple, convenient, portable mini-distillation apparatus for the production of essential oils and hydrosols, which is useful to distill essential oils and hydrosols such as rose water and ajowain water from fresh and/or dried plant material like leaves, flowers, roots and rhizomes by water distillation, water and steam distillations and optionally steam distillation. It may operable at atmospheric pressure as well as at slightly higher or lower pressures. The apparatus can be heated on a brick-clay furnace with small agro-waste, LPG cooking gas, electrically heated stove or kerosene/diesel burner etc. and requires minimum attention during handling; since the apparatus is made of stainless steel and glass, the essential oil distilled is of better quality.

Though suitable for small growers since it can process 1-5 kg of plant matter in a 3-5 hour period. The apparatus described therein is rather bulky, the chamber of which being 140 cm high and 32.5 cm vessel diameter. Consequently, it is not appropriate for domestic use, such as in a home kitchen for example.

Moreover, Babu's apparatus does not provide a solution to a fourth limitation of the Clevenger apparatus. Since the return tube directs the aqueous distillate back into the vapor flow impeding vapor flow into the condenser. With steam distillation this drawback becomes more acute as some volatile constituents may be hydrolyzed by the returning liquid in the delivery tube. Thus the efficiency of the distillation apparatus is compromised reducing yield and increasing operating time.

Another portable distillation apparatus is described in U.S. Pat. No. 5,951,825 to Land, titled “Convertible Distillation Apparatus”. Lands apparatus is a portable distiller convertible between an operating mode and a storage mode which permits easy transport. Land's distiller includes a boiler vessel, a condenser, and a collection container. The condenser is mounted on a two-way lid which engages the top of the boiler in an operating mode to support the condenser over the boiler. The lid is insulated to prevent the transfer of heat from the boiler to the condenser. The lid is reversible to allow the condenser to be inserted into the boiler vessel for storage. The container may also be stored in the boiler, and preferably receives the condenser for storage.

Once in its storage mode, Land's distiller is compact, convenient for transportation and useful for purifying water in areas with no power source. However Land's distiller has an air cooled condenser which is not suitable for the quick and efficient distillation of essential oils.

Thus there remains a need for a small, compact, simple to operate and easily stored apparatus for extracting volatile oils, particularly for domestic use, and the present invention addresses this need.

### BRIEF SUMMARY OF THE INVENTION

In a first aspect, the present invention is directed to providing a distillation apparatus for extracting volatile oils comprising:

at least one vessel comprising a container with an aperture thereinto and a lid for closing the aperture, the chamber being divided into at least one upper chamber and at least one lower chamber by at least one removable grid;
at least one condenser detachably coupled to said vessel via at least one delivery tube;
at least one collector for collecting a distillate; and
at least one return tube coupling the collector to the vessel;
wherein the dimensions of the vessel and its other components are selected such that said other components are storable within the vessel.

Typically the dimensions of the apparatus are selected such that said apparatus is stably supported and heated by the hob of a domestic stove.

Preferably the aperture is wide for easy loading and removal of plant materials.

Most preferably the container is cylindrical with a flat base, a curved side and the aperture is substantially equivalent to an open upper end of the pot.

Optionally the apparatus comprises at least one recirculating cooling system.

Typically the recirculating cooling system comprises at least one reservoir of contained coolant and at least one electric pump.

Preferably the recirculating cooling system further comprises an electric power source.

Optionally the power source is a vehicle battery.

Typically the contained coolant comprises water.

According to a second aspect, the present invention is directed to providing a distillation apparatus for extracting volatile oils wherein a return tube is configured to return an aqueous distillate to the lower chamber of the vessel.

According to a third aspect the present invention is directed to providing a distillation apparatus for extracting volatile oils wherein a return tube is configured to return an aqueous distillate to the delivery tube.

Optionally the grid is selected from the group comprising: a removable grid supported by at least three legs and covering the internal surface of the vessel and a collapsible stainless steel steamer; such that for steam distillation, the grid functions as a lid for the lower chamber and a base for the upper chamber and serving to support plant matter thereupon, to separate the plant matter from boiling water within lower chamber.

Typically the at least one grid is removable to provide one chamber for containing water and plant material for water distillation.

Optionally the apparatus comprises a dry cloth covering the top of the grid for extracting volatile oils from dried powdered plant matter by steam distillation.

Alternatively the apparatus further comprises a dry cloth for covering the grid for steam distillation extraction of volatile oils from particulate plant matter having a particle size of less than size of grid holes.

It is a further aspect of the present invention to provide a distillation apparatus for extracting volatile oils from plant matter comprising:

(a) a triple layer base for situating on a domestic stove for external heating thereby;
(b) a cylindrical side wall substantially perpendicular to the base to provide a container;
(c) an open top;
(d) a removable grid within the container, situated at a distance from the base of the vessel to generate a lower compartment for heating water therewithin for production of steam, and
(e) a removable lid to cover the open top, the lid having a vapor outlet couplable to an inlet of the reflux unit;
the condenser comprising a jacket with an inlet and outlet, couplable to an outlet of the reflux unit, and an outlet open to surrounding air, the jacket of the condenser being couplable by pipes to a water tank in a recirculating loop via the water pump to provide a recirculating flow of water to the condenser, said distillation apparatus being configured to be separated into component parts such that all component parts are storable within the vessel.

Typically, the apparatus further comprises a separation container comprising a short, thick and narrow clear glass tube, and a tap outlet for separation of the volatile oil from aqueous distillate.

In one embodiment, the removable grid comprises a collapsible stainless steel steamer with enlarged holes.

Where the apparatus is configured for use in water distillation, the removable grid is removed from the vessel and the plant matter is immersed in water.

Where the apparatus is configured for extracting volatile oils by steam distillation, said apparatus further comprises a cloth spread over the removable grid for use wherein the plant matter comprises a particulate of mean grain size smaller than holes in the grid.

Optionally, where the apparatus is configured for efficient production of volatile oils by steam distillation, said plant matter comprises matter selected from the list of dried and fresh plant material.

### BRIEF DESCRIPTION OF THE DRAWINGS

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice. In the accompanying drawings:

FIG. 1 is a schematic representation showing a distillation apparatus with a dispenser-vessel return tube according to one embodiment of the current invention;

FIG. 2 is a schematic representation showing a distillation apparatus with a collector-outlet return tube in accordance with another embodiment of the current invention;

### DETAILED DESCRIPTION OF THE INVENTION

Embodiments of the present invention are preferably compact. The diameter of the vessel is typically around 22.5 cm and height thereof is typically around 58 cm. This is suitable for use on the kitchen stove and for storage in a kitchen cupboard.

Unlike the apparatus described in U.S. Pat. No. 6,911,119 to Babu, the maximal plant material capacity of the apparatus of the preferred embodiments is about 200 grams for dried plant materials and 900 grams for fresh plant material, with an optimum charge of 120 and 500 grams for dried and fresh plant materials, respectively.

In consequence of the above, the preferred embodiments are particularly suitable for producing volatile oils safely in the home. It produces volatile oil on a very small scale in short times under simple conditions, such as standard domestic conditions. Being simple to operate, it may be used by unskilled people.

Thus the present invention relates to a distillation apparatus for extracting high quality plant volatile oils with high efficiency in a short time, typically 15-35 minutes (see Table 2 and 3). The apparatus is convenient, simple to operate and capable of extracting small volatile oil volumes in the range of approximately 0.5 to 16 ml per 1 kg of fresh plant material, depending on the plant type of course.

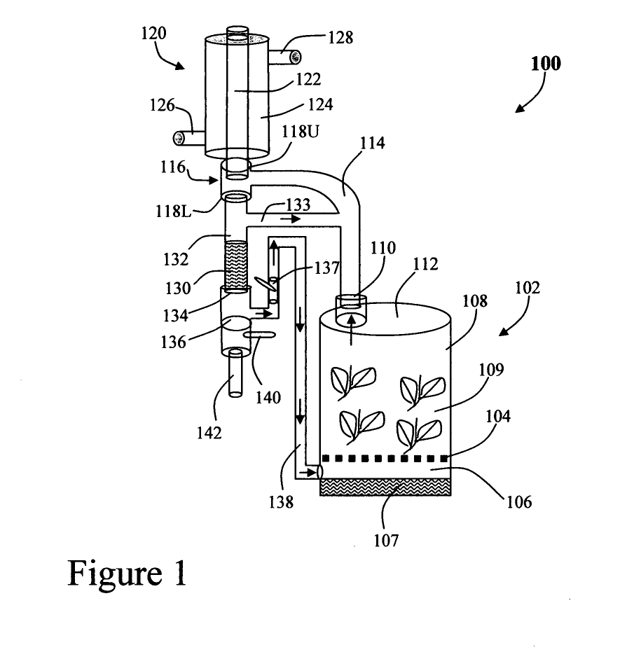

Reference is now made to FIG. 1 showing the apparatus 100 according to a first embodiment of the current invention. A grid 104 divides the vessel 102 into a lower chamber 106 into which water 107 may be introduced and an upper chamber 108 wherein plant matter 109, such as leaves, twigs, seeds, fruits, roots, flowers and the like may be introduced.

An outlet 110 in the removable lid 112 of the vessel is detachably coupled to a right-angled delivery tube 114 terminating in a T-junction 116. The upper outlet 118U of the T-junction 116 is detachably coupled to a condenser unit 120 comprising an inner condensing tube 122 enveloped by a jacket 124 having an inlet 126 and outlet 128 thereby providing passage of a coolant, typically water, between jacket 124 and inner condensing tube 122 for cooling and condensing vapors therewithin.

Vapors passing from the vessel 102 and through the delivery tube 114, pass into the condensing tube 122. The condensed distillate falls back through the T-junction 116 and into a receiver 130. The oil based distillate 132 having a low density typically separates from the aqueous distillate layer 134 which collects in a dispenser 136. The receiver 130 is coupled in fluid communication with the delivery tube 114 beneath the lower outlet 118L of the T-j unction 116, by means of an upper recycling line 133.

The dispenser 136 is coupled to a dispenser-vessel return tube 138 which returns the aqueous distillate to the lower chamber 106 of the vessel 102. The dispenser-vessel return tube may be selectively closed using a valve 137. This prevents backflow into the vessel.

Where the essential oil is denser than the water, the valve 137 within the return tube 133 should be closed, and the upper aqueous part of the distillate is recycled through the upper recycling line 133 only. In this case the denser oil accumulates at the bottom of the receiver 130. A rotary valve 140 is provided on the dispenser 136 for dispensing the oil 132 though a detachable nozzle 142.

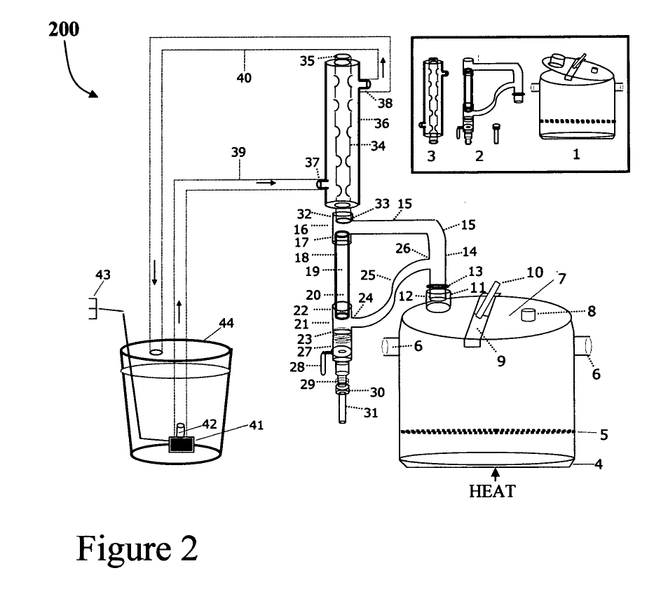

With reference to FIG. 2, a second embodiment of the present invention being a small and convenient domestic distillation apparatus 200 for the production of volatile oils and hydrosols is shown. The second embodiment 200 comprises a vessel 1, having two handles 6, and a lid 7, and provided with a grid 5 (or collapsible steamer) that is within the vessel 1, approximately 6 cm or so above its base. The lid 7 preferably includes at least one safety valve 8 and has a vapor outlet 11. The lid 7 is secured to the vessel 1 by a bridge-fastening 9 via a handle 10. The vapor outlet 11 is detachably coupled to an inlet 12 of a reflux unit 2.

The reflux unit 2 has one outlet 32 detachably coupled to an inlet 33 of a condenser 3. A second outlet 17 of the reflux unit 2 is detachably coupled to a glass separator 18 which serves as a receiving vessel (henceforth receiver) which is typically made of borosilicate glass (Pyrex®). The lower end of the receiver 18 is connected to a dispenser 22. An S-shaped collector-outlet returning pipe 25 connects the dispenser 22 to the inlet pipe 23 of the reflux unit. The returning pipe enables the excess water to flow back into the vapor flow from the vessel 1. The lower end 23 of the dispenser 22 includes a tap 27 that has a handle 28 for controlling the distillates outlet 29 through a detachable nozzle, which is a removable small glass pipe 31. The end 30 of the glass pipe 31 may be connected to the tap outlet 29 by a threaded connection, by a pressure fit connection or by the overlap of mating ground glass surfaces for example.

The condenser may consist of a narrow copper pipe 24, its lower end 33 detachably connected to the reflux unit outlet 32, and whose upper end 35 is open to surrounding air. A plastic jacket 36 having a jacket inlet 37 that is connected via a plastic pipe 39 to the water pump outlet 42, and having a jacket outlet 38 that is connected via a plastic pipe 40 back to the water tank 44, covers the copper pipe 34 and circulates water pumped by a small water pump 41 such as the Atman At-301 water pump for example.

In contrast with the requirements of Babu's apparatus and all other systems hitherto known to the inventor, it is noted that the condenser unit 3 of the second embodiment need not be connected to a water supply, such as a mains water supply. Rather, the coolant may be pumped from a self contained reservoir such as a bucket of water for example. This is a direct result of the small capacity and short operating times of this particularly compact, small scale apparatus. It is further noted that the small water pump draws little power and may be operated by direct current from a car battery or the like. In consequence of these features, the apparatus of the second embodiment 200 may be configured as a stand alone unit for use in the field.

In FIG. 2, the apparatus 200 is configured for steam distillation. In such a configuration, a volume of up to about 4 liters of water may be added to the vessel 1. Typically the level of the water in the vessel 1 is kept below the grid 5, the plant matter is placed onto the grid 5, which is perforated to allow steam to pass therethrough; the grid 5 serving as a separation or barrier between the plant material and the boiling water at the base of the vessel 1.

The grid 5 may be a steamer for example, perhaps modified by enlarging the perforations therewithin. Where used for steam distillation of a fine grained material having a particle grain size smaller than the size of the perforations in the grid 5, a cloth, typically a 100% cotton towel, may be used to trap the particulate, preventing it from passing through the perforations into the liquid at the base of the vessel, typically water.

The vessel 1 may be placed upon a stove or hob such as that of a domestic kitchen or camping burner for example. The heat from the stove or hob heats the water contained within the vessel thereby driving the distillation process.

The preferred embodiments are particularly suitable for use on an occasional basis by relatively unskilled people wishing to produce volatile oils on a very small scale for domestic needs. It is valuable for pedagogic purposes and may be used to learn the art, skill and science of volatile oil production. It may be used in simple conditions, such as in the domestic kitchen. The requirements are minimal. The apparatus of preferred embodiments meet the increasing demand for natural, fresh, pure volatile oils and plant extracts, unadulterated with that cheaper oils or synthetic components. Since the apparatus can extract such volatile oils by steam distillation and not just by hydro distillation, it may be utilized to extract high quality plant volatile oils for aromatherapy, perfumes and fragrances and the like.

It is a particular feature of preferred embodiments of the invention that the apparatus is fabricated from metal and/or plastic components and is easily dismantled for storage purposes. The vessel, reflux unit and condenser are suitable for use on the kitchen stove, whether ceramic, electric or gas, such as commonly found in domestic kitchens. Furthermore, the apparatus is designed such that all disassembled parts, including a small water pump provided for the recirculation cooling of the condenser, fit into the vessel, which is the size and shape of a saucepan or pressure cooker and the like, and thus readily stored in a small volume such as in a kitchen cupboard, or under the kitchen sink. Worth noting, since the condenser's jacket is not exposed to extremely high temperature during running, it is fabricated from plastic for reducing both, the condenser's vulnerability and the total weight of the apparatus as well.

For steam distillation, the apparatus is provided with a grid that may be installed internally within the vessel, above the base thereof, thereby generating a compartment and separating between the plant materials loaded on the grid and the boiling water therebelow. For hydro distillation the grid may be removed. Using the steam distillation method, the plant material capacity of the apparatus is restricted to a maximal volume of about 4 liters, which is suitable for loading with about 900 grams, of typical fresh leaves. With this plant matter volume, the apparatus facilitates the production of volatile oils with high efficiency. Although the optimal load is approximately 500 and 120 grams of fresh and dried plant material, respectively. It will be appreciated that the optimal capacity for dried plant material, whether ground, crushed or powdered, is typically much lower, is typically limited to approximately 500 grams or so, since dried plant material absorbs high amounts of water.

The apparatus is simple and safe to use, easily handled and requires minimal attention during operation. The weight of the apparatus is typically under 2.9 kg, its height is 58 cm, and it includes a cylindrical vessel with height/diameter values of 23/22.5 cm (8 liter volume), respectively. It produces volatile oils very efficiently, typically in 20 to 45 minutes or so.

The apparatus is compact and its parts are tough and difficult to break. Since the vessel has a small external base diameter, typically of 15 to 20 cm or so, it is stably and safely set up on the cooking stove of a domestic kitchen. The vessel has a wide mouth, typically 15 to 20 cm diameter or so. This facilitates: (a) both addition and removal of plant material, (b) cleaning the vessel after completion of the volatile oil extraction process and (c) inserting the other components of the apparatus into the vessel for compact storage when not in use.

Although designed for use in the domestic kitchen, the apparatus is also suitable for farmers/growers required to detect the quantity of volatile oils in a sample for determining the expected yield of a harvest, and for extraction for quality control purposes.

It is noted that unlike the Clevenger type apparatus of the prior art, which is a laboratory apparatus used also for distillation of volatile oils, in preferred embodiments of the current invention, glass is not used. Rather the components of preferred embodiments of the apparatus are fabricated from metal or plastic, thereby providing durability and safe and simple handling.

Referring back to FIG. 2, in another embodiment of the invention, when the apparatus 200 is applied for hydro distillation method, the grid 5 is removed from the vessel 1 and the charged plant material is immersed in water in a ratio 1:2 and 1:5 for fresh and dried plant materials, respectively, up to a distance of about 5 cm from the vessel mouth.

The vessel may be heated externally by any conventional heating means, such as on an electric or gas stove, for example.

In preferred embodiments, the apparatus is small in size and stable when assembled (58 cm total height, and 22.5 cm vessel diameter).

In preferred embodiments, the vessel 1, reflux unit 2, condenser 3 and recycling pipe 25 are made of metals (stainless steel and copper), plastic, and the use of glass is minimized. Where used at all, thick high-grade glass is used.

In one embodiment of the invention, the reflux unit 2 has relatively non-sensitive small receiver glass tube 18, which consists of high-grade glass (Pyrex), the visual length thereof, is about 12 cm. It may be provided as a measuring tube for determining the volume of the extracted volatile oil 19 while separating the aqueous lower phase 20 during the process. The maximal capacity of the reflux unit 2 is typically about 8 ml distilled volatile oil per run.

In yet another embodiment of the present invention, the condensing means is any conventional means such as water cooling condenser providing closed circulating system via a small electric water pump 41 situated within a reservoir 44 such as a bucket or similar, containing at least 8 or 9 liters of coolant, typically water. The reservoir 44 is connected to the condenser 3 via an incoming pipe 39 and a second, outgoing pip 40, both of which typically being lengths of 1 cm diameter plastic tubing. 50 cm to 1 m being suitable lengths. It has been found that a flow rate 2 liter/min performs adequately.

The vessel 1 is provided with two handles 6 attached thereto for carrying purposes. The lid is also typically provided with a handle 10, both to facilitate opening and closing of the vessel and for carrying purposes.

In yet another embodiment perfumed water may be produced, while the tap of the reflux unit 2 remains open. It has been found that up to 0.4 liter of hydrosol can be collected into separate containers within about 35 min.

In yet another embodiment, to extract volatile oils from dried powdered plant materials or plant slices having a size less than 3×3 mm, i.e. the pore size of the grid 5, a dry cloth, such as a 40 cm by 40 cm square of 100% cotton, may be set down on top of the grid 5 and the plant material may then be spread over the surface of the covered grid. Optionally, an additional dry cloth may be set down on top of the plant matter to capture and retain small particles, preventing them from flowing up with the steam during the distillation process.

The vessel 1 may be fabricated from stainless steel 18/10, for example. This is rust proof and easily washable, and is compatible with gas, halogen, ceramic and electric-stoves. The handles may be Bakelite or similar.

Inlet pipe 14 may be made of a copper with 23 cm length and 14/1.6 cm internal/external diameter to fit by insertion into the lid outlet 11, The inlet pipe may be welded to a right angle (having 16 mm internal diameter) at a distance of 10 cm or so, from its end 12 A 13 cm pipe is connected to the copper T piece 16 with 1/40 mm thickness/length. T-angle end 17 may be connected by means of a plastic connection, such as cross-linked polyethylene, for example, to the receiver separator glass tube end 18. The other T-angle end 32 is detachably coupled to the condenser inlet 33. The receiver separator glass tube 18 may be made of high-grade Pyrex, for example. Perhaps having a 12 cm visible (exposed) length, 1.5 mm thickness and 12 mm external diameter. The other end 18 thereof may be connected with propoxy 20 to the end 22 of a copper pipe 21 having 2.5 cm length and 14/16 mm internal/external diameter. A 21 cm length S-shaped piece of copper pipe 25 having an 8/10 mm internal/external diameter connects the middle 24 of this pipe 21 to the reflux unit inlet pipe 14 at a distance of about 6 cm 26 from the inlet end 12. The water that accumulates at the base of the receiver separator is fed back into the base of the vessel 1 through an S-shaped recycling tube 25 to increasing the yield of the volatile oil extracted. The end 23 of the pipe 21 under the receiver glass tube is connected to a small brass tap 27 being perhaps 5.5 cm long and 1.7 cm in diameter.

The condenser 3 consists of closed cylinder-like plastic jacket 36 and is about 20 cm long and 2.6 cm in internal diameter. A 23 cm long copper pipe 34 that is 1.6 cm wide passes through the jacket 36. The internal diameter of this pipe 34 is reduced from 1.4 cm to about 0.6 cm, at five sequential points; 6.5, 9.5, 13.5, 16.5 and 19 cm from the inlet end 33 and is attached to the reflux unit outlet 32. The other end 35 of the copper pipe 34 remains open to surrounding air (atmospheric pressure). The water from a reservoir 44, such as a 10 liter bucket containing 9 liter or so of tap-water, is transported to the condenser jacket 36 through two clear plastic pipes (about 70 cm length and 0.9 cm internal diameter) being connected between the jacked inlet 37 and outlet 38 ends. A small water pump (such as Atman At-301, 2 liter/min) situated within the water tank keeps the water in a cyclic circulation. While the apparatus is heated on a stove, for 45 min or so, this circulating system efficiently reduces the condenser's temperature, although the temperature of the water continually rises during the course of the distillation process. Optionally, where a longer extracting time is required (not recommended for domestic needs), the hot water in the reservoir 44 can be replaced by fresh tap-water for further extraction. Thus a single water replacement can practically overcome the limitation of using a holding tank.

In use, condensed volatile oil moves into the receiver glass tube 18 and accumulates 19 on top of the water phase 20. At the end of the distillation process, a small glass tube 31, perhaps 6 cm long, 6 mm external diameter and 4 mm internal diameter can be coupled 30 to the tap outlet 29 in order to visually follow the oil to be separately collected from the aqueous distillate. Separating the oil from water can occur while opening the tap by its handle 28 and removing, drop by drop, the water phase through the small glass tub 31. In almost all cases, the oil is lighter than the water, and the oil can be collected separately after the removal of the water at the lower phase. In case of oil being heavier than water, the tap should remain constantly open during the running, and collecting the first 250 ml condensed liquid into a narrow necked clear bottle. To float the oily phase at the base, 7.5 gram regular salt (5% NaCl, w/v) can be added into the bottle, and the floated oil can easily be collected by means of a small bottle pipette. Unlike the commercial production of volatile oils that requires a very high yield (100%); the production of volatile oil at home might be satisfied with a (significantly) lower yield, but having high quality while using a moderate distillation process.

The following examples are given by way of illustration of the device and the process of the present invention for the distillation of volatile oils and should not be construed to limit the scope of the present invention.

The following examples relate to the apparatus of FIG. 2:

### EXAMPLE 1

The volatile oils yield obtained by steam distillation from 100, 300, 500, 700 and 900 gram fresh rosemary (Rosemarinus officinalis L) branches (leaves and soft stems) is described. In the beginning, 0.8 liter of fresh water was charged into the vessel (1). The branches were then placed on the grid (5) and covered with a dry cloth (100% cotton 30×30 cm) that serves as a filter for capturing small particles joining the steams during the distillation process. The distance between the grid and water level was 2.5 mm. The vessel was placed on electric stove at a constant level (Hamilton hot plate at a level 4) that produces about 12 ml/min flow rate of distillate. The vessel was closed by the lid (7) and then the inlet (12) of the reflux unit was inserted into the vessel's outlet (11). As shown in FIG. 2, a basic bucket of 10 liter volume was filled with 9 liter tap water and the water pump that sits inside the water bucket. After connecting the plastic pipe (39) between the water pump and the inlet of the condenser jacket (37), and the other plastic pipe connected between the outlet pipe (38) of the condenser jacket and back to the bucket (44). The water pump was turned on, and after the insuring that the water circulating properly, by inverting the condenser twice to remove air bubbles, it was connected to inlet (32) of the reflux unit. The electric stove was turned on and fixed on a constant heat (at a level 4, which gives 12 ml/min follow rate of distillate) during the distillation process. After a few minutes (about 10 min), the water at the base of the vessel started to boil and to form steams, which then passes through the plant materials and extracts volatile oil present in it. A steam of water and oil comes out and reach the condenser through the reflux unit inlet pipe (12) and condensed in the condenser. The condensate was collected in the receiver glass tube (18). The oil as its density was lower than the water, settled as an upper layer (19) and the oil saturated water, as a lower layer (20). The oil-saturated water was recycled through recycling line (25), connected at the base (24) of oil receiver to the inlet pipe (26) of the reflux unit, to maintain the amount of the water in the system constant during the process, and reducing the attention that is needed while running a distillation apparatus, and to recover oil residues present in the water phase. The process was continued about 35 min and termed as a condensation time, and at the end of the process the heat source was stopped, and 2 min letter the water pump (41) turned off from the power (43) and the condenser disassembled from the reflux unit. There after a small glass tube (31) was connected to the tap outlet (29) before opening the tap (27). The water phase was removed slowly, drop by drop, to enable fine separation between oil and water phase. Following the water removal, the oil comes out and collected without residual of visible water. The oil in the receiver glass tub was measured and the results are presented in Table 1. Volatile oil volume was measured after 35 min condensation time (the time measured immediately after the condensed liquid starts to drip from the condenser to the receiver separator glass tube), and the total amount of volatile oil for each of the specified plant was based on the oil quantity which was obtained following condensation time, and non significant amount of oil was detected after 60 min.

The results in Table 1 show that the volume of the volatile oil collected in the receiver glass tube while extracting 500 gram rosemary was 4.6 ml, which reaches the highest recovery of 0.92%. These data gives some indication that 500 gram fresh plant material is an optimal quantity for steam distillation process of the apparatus. In further examples a quantity of 500 gram fresh plant materials were use. The essential oil of Rosemarinus officinalis is a popular oil in aromatherapy, where it energizing and stimulating. According to the international norms, the main constituents of this oil are: Borneol, Camphene, Camphor, Cineol, Lineol, Pinene and Terpineol. The volatile oil extracted from 500 gram rosemary as indicated in Table 1 was analyzed by gas chromatography coupled with mass spectrometry (GC-MS). Thirty four components were detected in the sample, and the major are: α-Pinene (17.51%), 1,8-Cineole (17.03%), Camphor (13.88%), Camphene (6.20%), Bomyl acetate (5.66%), Borneol (5.18%), β-Pinene (4.42%), α-Terpineol (3.70%) α-Phalandrene (3.52%), para-Cymene (2.82%), Linalool (2.65%), g-Trpinene (2.52%), Myrcane (2.30%), Verbenone (2.10%), α-Terpinene 1.99%), Terpinolene (1.35%), (E)-Caryophylene (1.32%) and the other with quantity less than 1%. This results conforms the international norms. It thus indicating the effectiveness of the apparatus to extract essential oils while using steam distillation process, particularly at a short running time as much as 35 min (condensation time).

TABLE 1
Experimental data showing the yield of volatile
oils extracted by steam distillation from different
quantities of fresh rosemary branches

| plant quantity | | | |
|---|---|---|---|
| (gr) | oil quantity (ml)* | % of oil extracted** | % of efficiency |
| 100 | 0.6 | 0.6 | 62.5 |
| 300 | 2.2 | 0.73 | 76 |
| 500 | 4.6 | 0.92 | 96 |
| 700 | 5.6 | 0.8 | 83 |
| 900 | 7.2 | 0.8 | 83 |

*Oil quantity was measured following 35 min, immediately after the condensed liquid starts to drip from the condenser to the receiver separator glass tube.
**The quantity of volatile oil extracted from 500 gram branches at 35 min condensation time was 4.6 ml, which is a 96%, as related to that extracted (4.8 ml) at a longer condensation time of 70 min.

### EXAMPLE 2

The experiment was done as described in example 1.500 gram of each plant branches (geranium, rosemary and lavender) was taken to extract volatile oil by steam distillation. Their volatile oils yields were measured in a different condensation time intervals as indicated in Table 2. The results show that almost all volatile oil quantity was recovered after 35 min condensation time while extracting 500 gram fresh plant materials. Thus it is recommended to charge the apparatus with 500 gram fresh plant material while using a steam distillation.

TABLE 2
Experimental data showing the yield of volatile oils
extracted by seam distillation from 500 gram fresh plant
material at different condensation time intervals

| | Volatile oil volume (ml) | | |
|---|---|---|---|
| Condensation time* (min) | geranium | rosemary | lavender |
| 5 | 0.6 | 1.8 | 5.0 |
| 10 | 1.0 | 2.9 | 7.0 |
| 15 | 1.2 | 3.3 | 7.5 |
| 20 | 1.4 | 3.8 | 7.7 |
| 25 | 1.5 | 4.1 | 7.7 |
| 30 | 1.5 | 4.4 | 7.7 |
| 35 | 1.5 | 4.6 | 7.7 |

*A longer condensation time of 70 min was done for each sample and the volatile oil yield considered as a maximum yield. The calculated volatile oil utilization indicated that the yield of each plant material is above 90%.

### EXAMPLE 3

The experiment was done as described in example 1, but in addition, a dry cloth (100% cotton 40×40 cm) was set down on top of the grid (5), and the dried powdered plant material then placed on the cloth and spread homogenously on the entire top surface of the grid.

The yield of volatile oils was extracted from various quantities: 40, 120, 200 and 500 gram dried powdered cardamom, and the volatile oil amount at different condensation time intervals was measured and presented in Table 3. The results indicate that a dried powdered plant material (cardamom fruits seeds) gives the highest volatile oil production, while charging the apparatus with 40 and 120 gram and running during 35 min condensation time. Thus, to obtain an optimal yield, it is recommended to charge the apparatus with about 120 gram dried plant material while using a steam distillation method. While extracting dried plant materials, it is recommended to limit the plant quantity up to 500 gram, as the dried plant materials absorbed a lot of water, and extending the condensation time above 35 min required adding of further amount of water (0.5 liter) to be the vessel.

TABLE 3
Experimental data showing the yield of volatile oils extracted
by steam distillation from various amounts of a dried powdered
cardamom fruits at different condensation time intervals

| | volatile oil volume (ml) of cardamom fruits | | | |
|---|---|---|---|---|
| Condensation time* (min) | 40 gr | 120 gr | 200 gr | 500 gr |
| 5 | 1.1 | 3.5 | 4.5 | — |
| 10 | 1.5 | 4.8 | 5.8 | 1.5 |
| 15 | 1.7 | 5.2 | 6.4 | 4.5 |
| 20 | 1.8 | 5.5 | 6.8 | 6.5 |
| 25 | 1.85 | 5.6 | 7.0 | — |
| 30 | 1.9 | 5.7 | 7.1 | — |
| 35 | 1.9 | 5.7 | 7.2 | 10.3 |
| % of efficiency | 100 | 100 | 76 | 43 |

*A longer condensation time for the sample 40 gr cardamom was measured at 70 min condensation time and yields 1.9 ml volatile oil. This quantity was considered as a maximum yield for calculating the volatile oil utilization after 35 min of condensation time.

### EXAMPLE 4

The experiment compares the yield of volatile oil obtained by the apparatus of the present invention and a glass-made Clevenger having a similar shape, but with longer glass tubes (113 cm total length), vertical condenser and a spherical vessel with 10 liter capacity (34 cm maximal diameter). The experiment with the apparatus of the present invention was done as described in example 1, but the electric stove fixed on a lower level (level 3.5) that gives 10 ml/min flow rate of distillate. While using the Clevenger apparatus, a similar flow rate was achieved when the stove fixed on a constant heat source at a higher level (level 5, which gives 10 ml/min flow rate). At a heat level above 5 (, the Clevenger condenser (30 cm length) is inefficient and significant portion of the steams leave out through the condenser opened end. As the condenser of the present invention has a cupper pipe with a shorter size (20 cm length), it is efficient at list up to 18 ml/min follow rate of distillates, which can be obtained at electric stove level 5.5. Both apparatus were charged with 500 gram flowering branches of lavender (Lavandula dentata). The plant material in the Clevenger was carried out under water distillation method by immersing in water (2 liter), whereas the apparatus of the present invention done under steam distillation technique as indicated in experiment 1.

Results listed in Table 4 indicate that the steam distillation method of the present apparatus yields higher volatile oil quantity than the Clevenger type apparatus. The volatile oil collected in the graduated glass receiver of the present invention apparatus after 30 min was measured to 4.2 ml versus 2.9 ml obtained by the Clevenger, which is 31% increase. The maximal volatile oil quantity obtained by the Clevenger following one hour condensation time was 21% lower than that of the present invention apparatus.

TABLE 4
Experimental data comparing the yield of volatile oils extracted
by the present invention apparatus (using steam distillation
method) versus the Clevenger apparatus from 500 gram fresh
flowering branches of lavender (Lavandula dentata) at different
condensation time intervals

| Condensation | Quantity of volatile oil (ml) | | |
|---|---|---|---|
| time (min) | Clevenger apparatus | present apparatus | increase (%) |
| 10 | 2.2 | 3.5 | 37 |
| 20 | 2.7 | 4.1 | 34 |
| 30 | 2.9 | 4.2 | 31 |
| 40 | 3.0 | 4.3 | 30 |
| 50 | 3.4 | 4.3 | 21 |
| 60 | 3.4 | — | — |

Thus the scope of the present invention is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

1. A distillation apparatus for extracting volatile oils from plant matter, the apparatus comprising the following components:
a. at least one vessel comprising a container with an open mouth, the container being divided into at least one upper chamber and at least one lower chamber by at least one removable grid;
b. a lid for covering the open mouth;
c. at least one condenser detachably coupled to said vessel via at least one delivery tube;
d. at least one collector for collecting a distillate;
e. at least one return tube coupling the collector to the vessel;
f. a recirculating cooling system comprising at least one electric pump and outgoing and incoming conduits for coupling to at least one reservoir of contained coolant liquid,
wherein the dimensions of the components are selected such that the condenser, collector and return tube are storable within the vessel.

2. The apparatus of claim 1, dimensions of which are selected such that said apparatus is stably supportable on a hob of a domestic stove for heating thereby.

3. The apparatus of claim 1 wherein said mouth enables the loading and removal of plant matter.

4. The apparatus of claim 1 wherein said reservoir is a bucket.

5. The apparatus of claim 1 wherein said pump is powered by a low voltage DC supply.

6. The apparatus of claim 1 for coupling to an accumulator of a vehicle.

7. The apparatus of claim 1 for coupling via a transformer to a mains power supply.

8. The apparatus of claim 1 wherein said contained coolant comprises water.

9. The apparatus of claim 1 wherein said return tube is configured to return an aqueous distillate to the lower chamber of the vessel.

10. The apparatus of claim 1 wherein said return tube is configured to return an aqueous distillate to the delivery tube.

11. The apparatus of claim 1 wherein the at least one grid is selected from the group comprising:
a. a removable grid supported by legs and covering the internal surface of the vessel; and
b. a collapsible stainless steel steamer;
such that at least two chambers are formed separating boiling water from plant material for steam distillation.

12. The apparatus of claim 1, wherein the at least one grid is removable to provide one chamber for containing water and plant material for water distillation.

13. The apparatus of claim 1 further comprising a cloth covering the top of the grid for extracting volatile oils from dried powdered plant matter by steam distillation.

14. The apparatus of claim 1 comprising:
a vessel;
a reflux unit;
a condenser;
a water pump;
the apparatus for operating in a domestic environment for the extraction of high quality plant volatile oils by a distillation process selected from the group comprising steam distillation and water distillation,
the vessel comprising:
a triple layer base for situating on a domestic stove for external heating thereby;
a cylindrical side wall substantially perpendicular to the base to provide a container;
a removable grid within the container, situated at a distance from the base of the vessel to generate a lower compartment for heating water therewithin for production of steam, and
a removable lid to provide a large aperture, the lid having a vapor outlet couplable to an inlet of the reflux unit;
the condenser comprising a jacket with an inlet and outlet, couplable to an outlet of the reflux unit, and an outlet open to surrounding air, the jacket of the condenser being couplable by pipes to a water tank in a recirculating loop via the water pump to provide a recirculating flow of water to the condenser, said distillation apparatus being configured to be separated into component parts such that all component parts are storable within the vessel.

15. The apparatus of claim 1 comprising a separation container comprising a short, narrow clear glass tube and a tap outlet for separation of a volatile oil from aqueous distillate.

16. The apparatus of claim 1 wherein said removable grid comprises a collapsible stainless steel steamer with enlarged holes.

17. The apparatus of claim 1 when for use in water distillation method, the removable grid is removed from said vessel and plant matter is immersed in water.

18. The apparatus of claim 1 for extracting volatile oils by steam distillation, further comprising a cloth spread over the removable grid wherein plant matter comprises a particulate of grain size smaller than holes in the grid.

19. The apparatus of claim 1 for efficient production of volatile oils by steam distillation wherein plant matter comprises matter selected from the group of dried plant material and fresh plant material.
